(19) United States
(12) Patent Application Publication
(10) Pub. No.: US 2011/0202290 A1
(43) Pub. Date: Aug. 18, 2011

(54) MULTI-DIMENSION DETECTOR WITH HALF BRIDGE LOAD CELLS

(75) Inventors: Pi-Lieh CHANG, Kaohsiung City (TW); Ta-Jen Lin, Jhubei City (TW); Chung-Liang Lin, Chiayi City (TW); Chang-Chun Lung, Jhubei City (TW)

(73) Assignee: Justtec Corporation, HsinChu (TW)

(21) Appl. No.: 13/097,341

(22) Filed: Apr. 29, 2011

Related U.S. Application Data
(63) Continuation-in-part of application No. 12/216,932, filed on Jul. 14, 2008.

(30) Foreign Application Priority Data
Apr. 11, 2008 (TW) 097113175

(51) Int. Cl. G01L 1/22

(52) U.S. Cl. 702/42

(57) ABSTRACT

A multi-dimension detector with half bridge load cells, which includes an analog to digital converter (ADC), a plurality of half bridge load cells, an analog multiplexer and a central processing unit (CPU). The CPU controls the analog multiplexer to form a plurality of full bridge load cells by selecting either two of the half bridge load cells and detect a plurality of measures corresponding to an object. The ADC converts analog signals corresponding to the plurality of measures into digital signals. The CPU determines all dimension values of the object according to the plurality of measures corresponding to the digital signals.

### CROSS REFERENCE TO RELATED APPLICATION

This application is a continuation-in-part (CIP) of U.S. patent application for “multi-dimension detector with half bridge load cells”, U.S. application Ser. No. 12/216,932, filed on Jul. 14, 2008.

### BACKGROUND OF THE INVENTION

1. Field of the Invention

The present invention relates to a multi-dimension detector with half bridge load cells and, more particularly, to a multi-dimension detector with half bridge load cells used for the object's position detection.

2. Description of Related Art

A conventional load cell is typically used in the weight measurement. FIG. 1 shows a diagram of a load cell circuit used as an electronic weight gauge, for example, where the strain gages C1 , C2, T1 and T2 form a full bridge load cell, which is known as a Wheatstone bridge. The Wheatstone bridge is applied an external voltage source (E+, E−) and installed in a strain generator. When the strain generator applies the full bridge load cell on a strain sensing area to sense a strain generation, the resistance values of the strain gages C1 and C2 are changed in an opposite direction with respect to the resistance values of the strain gages T1 and T2, and thus the full bridge load cell generates output voltages Vo+ and Vo−, which are further applied to the inverse input terminal and non-inverse input terminal of the operational amplifier 91 and performed a signal processing to thereby obtain an output value corresponding to the strain. When the full bridge load cell is applied in a multi-dimension detector system, one or more full bridge load cells are typically used to measure the dimension values in a one to one manner. However, with the measurement increase on the number of dimensions, the entire system relatively becomes complicated and costly, and the calibration consumes more time. Therefore, it is desirable to provide an improved system to mitigate and/or obviate the aforementioned problems.

### SUMMARY OF THE INVENTION

The object of the present invention is to provide a multi-dimension detector with half bridge load cells, which uses the half bridge load cells having lower cost and simple structure and a switching circuit to detect a dimension value such as an object position, thereby effectively reducing the cost and increasing the performance.

According to a feature of the invention, a multi-dimension detector with half bridge load cells is provided, which detects a dimension value of an object on each dimension. The detector includes an analog to digital converter, which converts analog signals into digital signals; three half bridge load cells which are first, second and third half bridge load cells, each having two load components connected in series; an analog multiplexer, which interconnects the first and second half bridge load cells to form a first full bridge load cell to thereby detect a first force measure corresponding to the object, interconnects the second and third half bridge load cells to form a second full bridge load cell to thereby detect a second force measure corresponding to the object, interconnects the first and third half bridge load cells to form a third full bridge load cell to thereby detect a third force measure corresponding to the object, and transmits the analog signals corresponding to the first, second and third force measures on the first, second and third full bridge load cells to the analog to digital converter for a conversion from the analog signals into the digital signals; and a central processing unit, which determines position and weight of the object according to the first, second and third force measures corresponding to the digital signals.

According to another feature of the invention, a multi-dimension detector with half bridge load cells is provided, which detects position and weight of an object. The detector includes an analog to digital converter, which converts analog signals into digital signals; four half bridge load cells which are first, second, third and fourth half bridge load cells, each having two load components connected in series; an analog multiplexer, which interconnects the first and second half bridge load cells to form a first full bridge load cell to thereby detect a first force measure corresponding to the object, interconnects the third and fourth half bridge load cells to form a second full bridge load cell to thereby detect a second force measure corresponding to an object, interconnects the first and fourth half bridge load cells to form a third full bridge load cell to thereby detect a third force measure corresponding to the object, interconnects the second and third half bridge load cells to form a fourth full bridge load cell to thereby detect a fourth force measure corresponding to the object, and transmits the analog signals corresponding to the first, second, third and fourth force measures on the first, second, third and fourth full bridge load cells to the analog to digital converter for a conversion from the analog signals into the digital signals; and a central processing unit, which determines the position and weight of the object according to the first, second, third and fourth force measures corresponding to the digital signals.

Other objects, advantages, and novel features of the invention will become more apparent from the following detailed description when taken in conjunction with the accompanying drawings.

### BRIEF DESCRIPTION OF THE DRAWINGS

FIG. 1 is a diagram of a typical circuit of a full bridge load cell;

FIG. 2(a) shows a system configuration of a multi-dimension detector with half bridge load cells according to the invention;

FIG. 2(b) shows a schematic graph of an M(M-1)/2 dimension number formed of M half bridge load cells according to the invention;

FIG. 2(c) shows a schematic graph of the analog multiplexer according to the invention;

FIG. 2(d) schematically illustrates using switch units of the analog multiplexer to connect the terminals of two half bridge load cells to form a full bridge load cell;

FIG. 3 is a configuration diagram of using a multi-dimension detector with half bridge load cells to detect position and weight of an object according to the invention;

FIGS. 4(a)-(e) show a schematic chart of an operation with three half bridge load cells according to the invention;

FIGS. 5(a)-(c) show a schematic graph of a computation with three half bridge load cells according to the invention;

FIGS. 6(a)-(d) show a schematic chart of an operation with four half bridge load cells according to the invention; and

FIGS. 7(a)-(c) show a schematic chart of a computation with four half bridge load cells according to the invention.

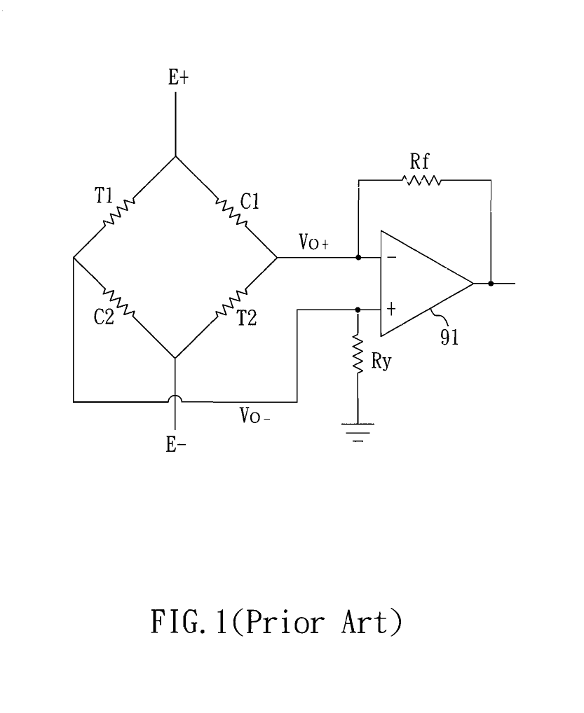

### DETAILED DESCRIPTION OF THE PREFERRED EMBODIMENT

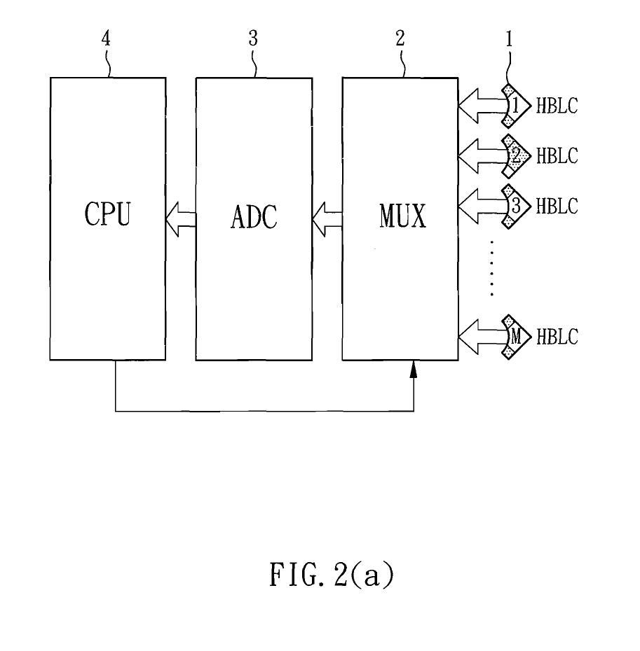

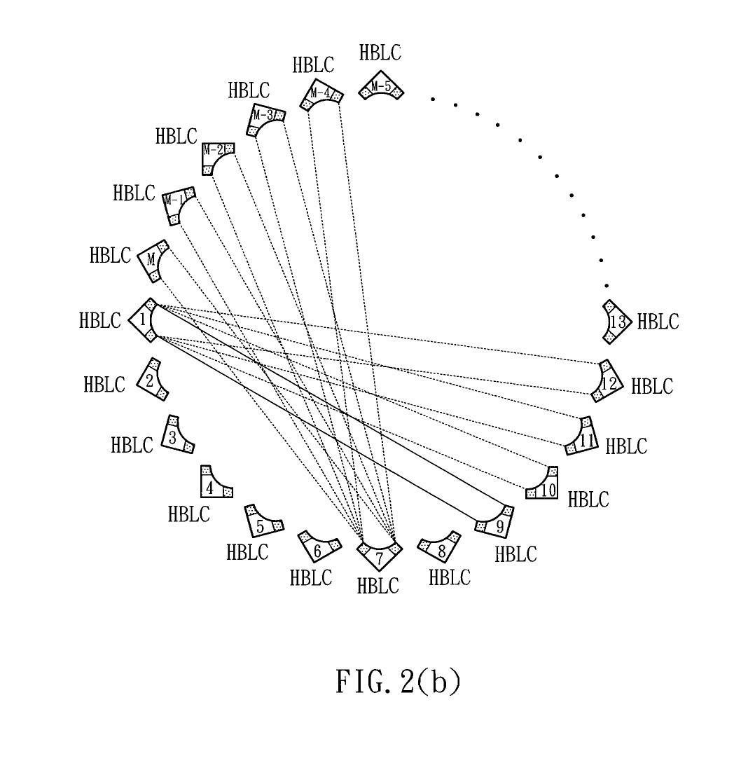

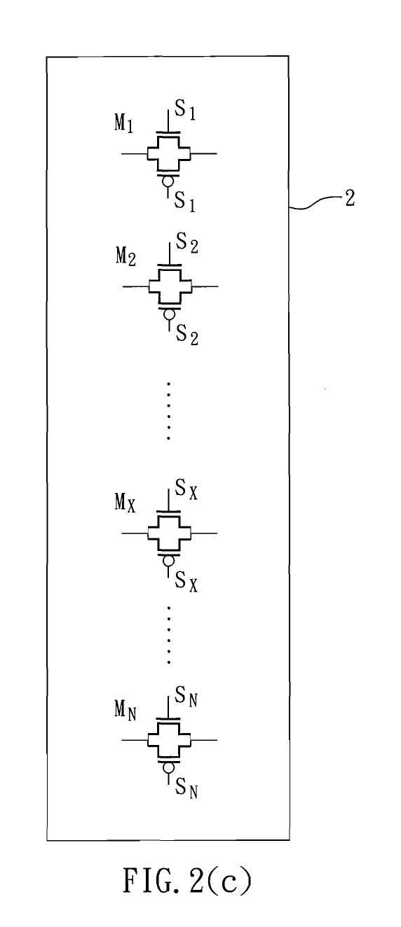

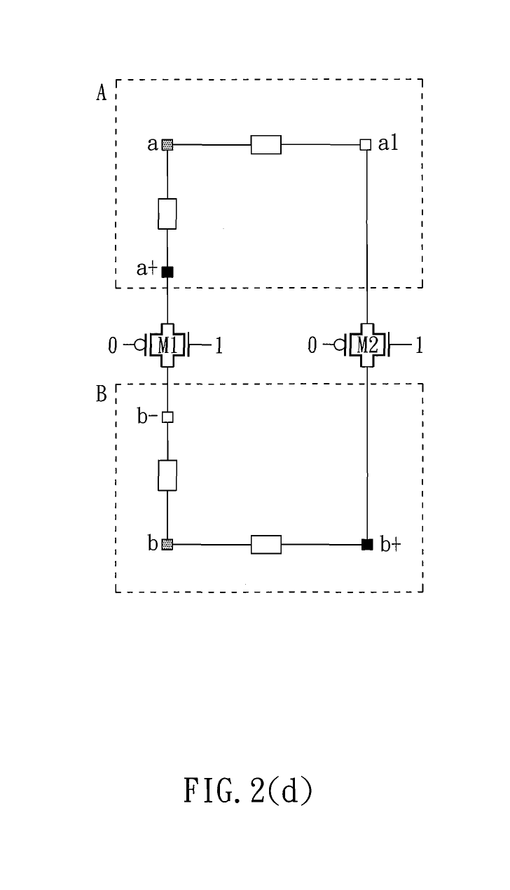

FIG. 2(a) shows a system configuration of a multi-dimension detector with half bridge load cells according to the invention. As shown in

FIG. 2(a), the detector includes a plurality of half bridge load cells (HBLC) 1, an analog multiplexer (MUX) 2, an analog to digital converter (ADC) 3 and a central processing unit (CPU) 4. The analog multiplexer 2 is controlled by the CPU 4 to interconnect different HBLCs 1 to form a complete full bridge load cell and transmit analog signals on the complete full bridge load cell to the ADC 3. The ADC 3 receives and converts the analog signals into corresponding digital signals. The CPU 4 performs a mathematical operation on the measures corresponding to the digital signals to thereby determine a dimension value of the object on each dimension.

FIG. 2(b) shows a schematic graph of an M(M-1)/2 dimension number formed of M half bridge load cells 1 according to the invention. For example, when three half bridge load cells 1 are applied, the first and the second half bridge load cells 1 form a first full bridge load cell to thus obtain the first dimension, the first and the third half bridge load cells 1 form a second full bridge load cell to thus obtain the second dimension, and the second and the third half bridge load cells 1 form a third full bridge load cell to thus obtain the third dimension. Accordingly, three half bridge load cells 1 can form three dimensions. Similarly, when four half bridge load cells 1 are applied, six dimensions are formed. Thus, when M half bridge load cells 1 are applied, M(M-1)/2 dimensions are formed.

FIG. 2(c) shows a schematic graph of the analog multiplexer 2, which is composed of a plurality of switch units Mx (x=1 . . . n, n is an integer larger than 2), each switch unit Mx being formed by combining a PMOS and an NMOS. Each of the switch units Mx is controlled by control signal Sx, preferably produced by the CPU 4, to be switched on or off. The switch units Mx are used to connect the terminals of two half bridge load cells 1 to be a full bridge load cell. For example, as shown in FIG. 2(d), for the two half bridge load cells 1, indicated by A and B respectively, a switch unit M1 of the analog multiplexer 2 is switched on to connect the terminal a+ of the half bridge load cell A with the terminal b− of the half bridge load cell B, and a switch unit M2 of the analog multiplexer 2 is switched on to connect the terminal a− of the half bridge load cell A with the terminal b+ of the half bridge load cell B, so as to form a full bridge load cell.

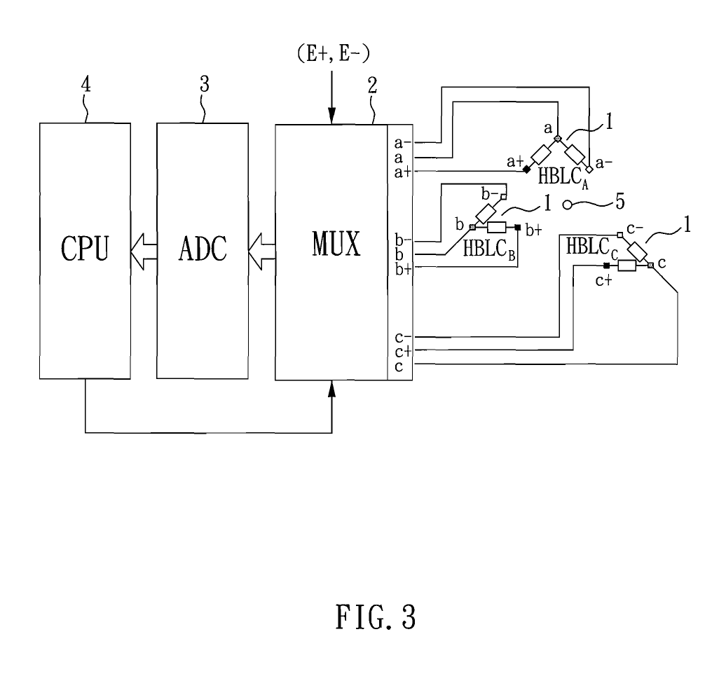

FIG. 3 is a configuration diagram of using a multi-dimension detector with half bridge load cells to detect position and weight of an object 5 according to the invention. In this case, three half bridge load cells 1, an analog multiplexer 2, an ADC 3 and a CPU 4 are applied for detecting the position and weight of the object 5 disposed on a plane formed by the three half bridge load cells 1. The three half bridge load cells 1 are connected to the analog multiplexer 2. The analog multiplexer 2 controls the interconnection of the half bridge cells 1 and transmits the analog signals generated by the half bridge cells 1 to the ADC 3. The ADC 3 converts the analog signals into the digital signals and sends the digital signals to the CPU 4. The CPU 4 accordingly computes the corresponding position and weight.

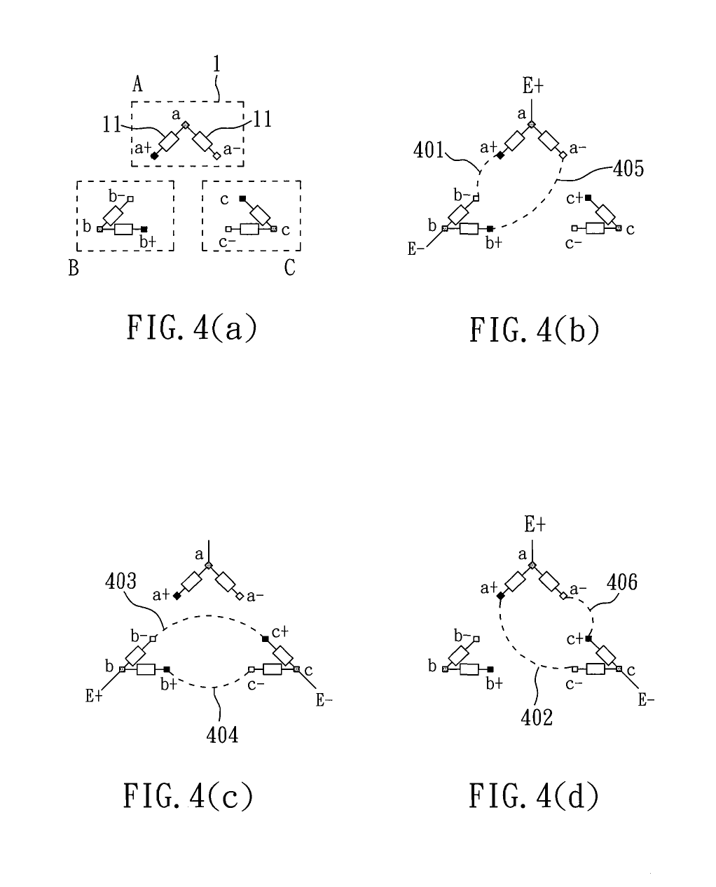

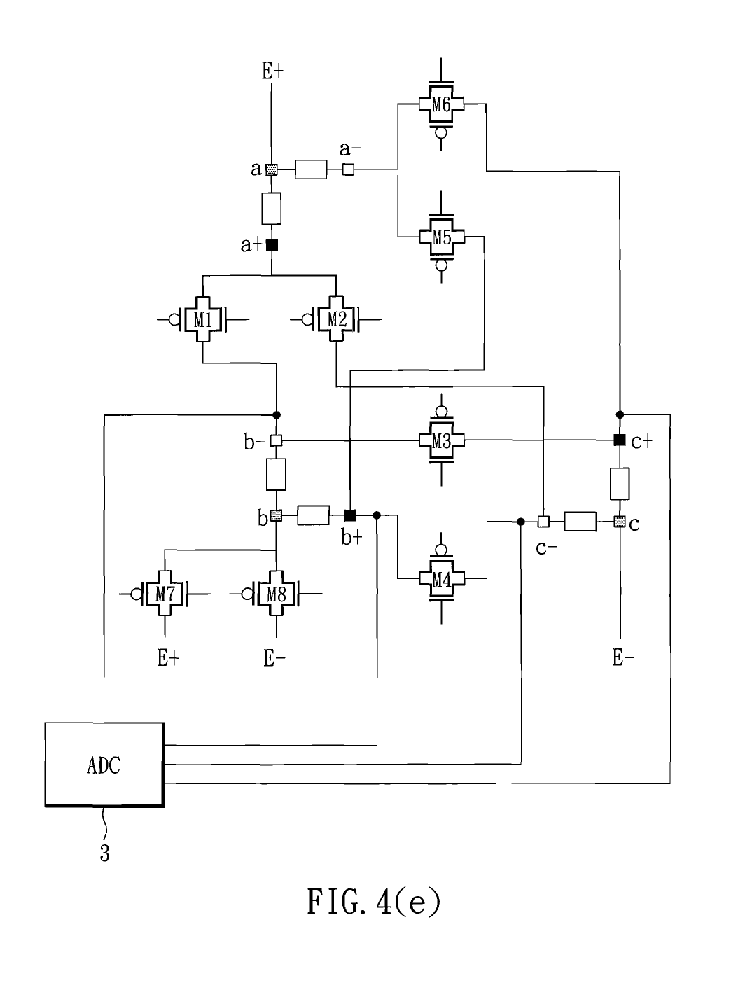

FIGS. 4(a)-(e) show a schematic chart of an operation with three half bridge load cells according to the invention. As shown in FIG. 4(a), symbols A, B and C respectively indicate a half bridge load cell 1. The three half bridge load cells A, B, C have two load components 11 connected in series and three terminals each. For example, the half bridge load cell A has three terminals a−, a+, a, the half bridge load cell B has three terminals b−, b+, b, and the half bridge load cell C has three terminals c−, c+, c. FIG. 4(e) further demonstrates the connection of the analog multiplexer 2 and the three half bridge load cells A, B, C, in which the analog multiplexer 2 has eight switch units M1-M8. The switch unit M1 has two ends connected to terminal a+ of the half bridge load cell A and terminal b− of the half bridge load cell B, respectively. The switch unit M2 has two ends connected to terminal a+ of the half bridge load cell A and terminal c− of the half bridge load cell C, respectively. The switch unit M3 has two ends connected to terminal b− of the half bridge load cell B and terminal c+ of the half bridge load cell C, respectively. The switch unit M4 has two ends connected to terminal b+ of the half bridge load cell B and terminal c− of the half bridge load cell C, respectively. The switch unit M5 has two ends connected to terminal a− of the half bridge load cell A and terminal b+ of the half bridge load cell B, respectively. The switch unit M6 has two ends connected to terminal a− of the half bridge load cell A and terminal c+ of the half bridge load cell C, respectively. The switch unit M7 has two ends connected to terminal b of the half bridge load cell B and external voltage source E+, respectively. The switch unit M8 has two ends connected to terminal b of the half bridge load cell B and external voltage source E−, respectively. The terminal c of the half bridge load cell C is connected to external voltage source E−. The terminal a of the half bridge load cell A is connected to external voltage source E+. The terminal a of the half bridge load cell A is connected to external voltage source E+. The terminals b−, b+ of the half bridge load cell B and the terminals c−, c+ of the half bridge load cell C are connected to ADC 3.

As shown in FIG. 4(b), the analog multiplexer 2 interconnects the half bridge load cell A and B to form a full bridge load cell, wherein the dash line 401 indicates that the switch unit M1 of the analog multiplexer 2 is switched on to connect end point a+ of the half bridge load cell A with end point b− of the half bridge load cell B; the dash line 405 indicates that the switch unit M5 of the analog multiplexer 2 is switched on to connect end point a− of the half bridge load cell A with end point b+ of the half bridge load cell B; external voltage source E+ is connected to end point a of the half bridge load cell A; external voltage source E− is connected to end point b via the switch unit M8 which is switched on. Therefore, a full bridge load cell is formed by connecting the terminal a+ of the half bridge load cell A to the terminal b− of the half bridge load cell B and connecting the terminal a− of the half bridge load cell A to the terminal b+ of the half bridge load cell B. Further, the terminal a of the half bridge load cell A and the terminal b of the half bridge load cell B are connected to the external voltage source (E+, E−), and in this case the full bridge load cell formed of the half bridge load cells A and B can detect a first signal.

As shown in FIG. 4(c), the analog multiplexer 2 interconnects the half bridge load cell B and C to form a full bridge load cell, wherein the dash line 403 indicates that the switch unit M3 of the analog multiplexer 2 is switched on to connect end point b− of the half bridge load cell B with end point c+ of the half bridge load cell C; the dash line 404 indicates that the switch unit M4 of the analog multiplexer 2 is switched on to connect end point b+ of the half bridge load cell B with end point c− of the half bridge load cell C; external voltage source E+ is connected to end point b of the half bridge load cell B via the switch unit M7 which is switched on; external voltage source E− is connected to end point c of the half bridge load cell C. Therefore, a full bridge load cell is formed by connecting the terminal b+ of the half bridge load cell B to the terminal c− of the half bridge load cell C and connecting the terminal b− of the half bridge load cell B to the terminal c+ of the half bridge load cell C. Further, the terminal b of the half bridge load cell B and the terminal c of the half bridge load cell C are connected to the external voltage source (E+, E−), and in this case the full bridge load cell formed of the half bridge load cells B and C can detect a second signal.

As shown in FIG. 4(d), the analog multiplexer 2 interconnects the half bridge load cell A and C to form a full bridge load cell, wherein the dash line 406 indicates that the switch unit M6 of the analog multiplexer 2 is switched on to connect end point a− of the half bridge load cell A with end point c+ of the half bridge load cell C; the dash line 402 indicates that the switch unit M2 of the analog multiplexer 2 is switched on to connect end point a+ of the half bridge load cell A with end point c− of the half bridge load cell C; external voltage source E+ is connected to end point a of the half bridge load cell A; external voltage source E− is connected to end point c of the half bridge load cell C. Therefore, a full bridge load cell is formed by connecting the terminal a+ of the half bridge load cell A to the terminal c− of the half bridge load cell C and connecting the terminal a− of the half bridge load cell A to the terminal c+ of the half bridge load cell C. Further, the terminal a of the half bridge load cell A and the terminal c of the half bridge load cell C are connected to the external voltage source (E+, E−), and in this case the full bridge load cell formed of the half bridge load cells A, C can detect a third signal.

The first to third signals are transmitted to the ADC 3 for being converted into the digital signals by the ADC 3, and the digital signals are sent to the CPU 4 in order to compute the corresponding position and weight.

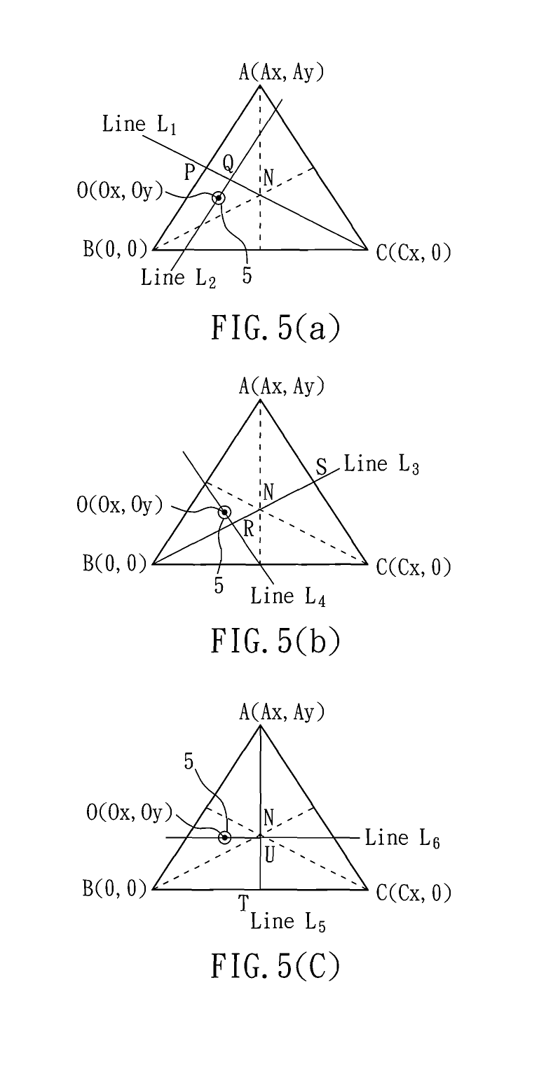

FIGS. 5(a)-(c) show a schematic graph of a computation with three half bridge load cells according to the invention. As shown in FIG. 5(a), the three half bridge load cells 1 A, B, C form a triangle plane, where B is at the origin, A is at a position (Ax, Ay), C is at a position (Cx, 0), O(Ox, Oy) indicates the position of an object 5 in the triangle plane, N indicates the center of gravity of the triangle plane which is at the intersection of the midline passing through point A and middle of line BC, and the midline passing through point B and middle of line AC, L1 indicates a line passing through C(Cx, 0) and the center of gravity N, which intersects a line passing through A and B (line AB) at a point P, and L2 indicates a line passing through O(Ox, Oy) and parallel to the line AB, which intersects the line L1 at a point Q. The triangle plane formed of the three half bridge load cells A, B, C can be represented as follows:

$$\begin{matrix}AB -> y = \frac{Ay}{Ax} x , & ( 1 ) \\ A C -> y = \frac{Ay}{Ax - Cx} ( x - Cx ) , & ( 2 ) \\ L 1 -> y = \frac{Ny}{Nx - Cx} ( x - Cx ) , & ( 3 ) \\ L 2 -> y - Oy = \frac{Ay}{Ax} ( x - Ox ) . & ( 4 )\end{matrix}$$

P(Px, Py) and Q(Qx, Qy) can be derived from the above equations (1)-(4) as follows.

$$P ( Px , Py ) … ( 1 ) + ( 3 ) , \\ Q ( Qx , Qy ) … ( 3 ) + ( 4 ) , \\ Px = \frac{AxCxNy}{Ay ( Cx - Nx ) + AxNy} , \\ Qx = \frac{( AyOx - AxOy ) ( Cx - Nx ) + AxCxNy}{Ay ( Cx - Nx ) + AxNy} .$$

Thus, the force F_{AB}(Ox, Oy) sensed by the object 5 is:

$${F}_{AB} ( Ox , Oy ) = \frac{Cx - Qx}{Cx - Px} W , \\ \begin{matrix}{F}_{AB} ( Ox , Oy ) = \frac{Cx - \frac{( AyOx - AxOy ) ( Cx - Nx ) + AxCxNy}{Ay ( Cx - Nx ) + AxNy}}{AxCxNy} W \\ = ( 1 - \frac{1}{Cx} x + \frac{Ax}{CxAy} y ) W ,\end{matrix}$$

where W indicates a weight of the object 5.

As shown in FIG. 5(b), the three half bridge load cells A, B, C form a triangle plane, where B is at the origin, A is at a position (Ax, Ay), C is at a position (Cx, 0), O(Ox, Oy) indicates the position of an object 5 in the triangle plane, N indicates the center of gravity of the triangle plane, which is at the intersection of the midline passing through point A and middle of line BC, and the midline passing through point C and middle of line AB, L3 indicates a line passing through the origin B( 0,0) and the center of gravity N, which intersects a line passing through point A and point C (line AC) at a point S, and L4 indicates a line passing through O(Ox, Oy) and parallel to the line AC, which intersects the line L3 at a point R. The triangle plane formed of the three half bridge load cells A, B, C can be represented as follows.

$$\begin{matrix}AB -> y = \frac{Ay}{Ax} x , & ( 1 ) \\ A C -> y = \frac{Ay}{Ax - Cx } ( x - Cx ) , & ( 2 ) \\ L 3 -> y = \frac{Ny}{Nx} x , & ( 3 ) \\ L 4 -> y - Oy = \frac{Ay}{Ax - Cx} ( x - Ox ) . & ( 4 )\end{matrix}$$

S(Sx, Sy) and R(Rx, Ry) can be derived from the above equations (1)-(4) as follows.

$$S ( Sx , Sy ) … ( 2 ) + ( 3 )$$

$$R ( Rx , Ry ) … ( 3 ) + ( 4 )$$

$$Sx = \frac{AxCxNy}{Ny ( Cx - Ax ) + AyNx} , \\ Rx = \frac{Nx ( Cx - Ax ) + {NxA}_{Y} Ox}{Ny ( Cx - Ax ) + AyNx} .$$

Thus, the force F_{AC}(Ox, Oy) sensed by the object 5 is:

$${F}_{A C} ( Ox , Oy ) = \frac{Rx}{Sx} W , \\ \begin{matrix}{F}_{A C} ( Ox , Oy ) = \frac{Nx ( Cx - Ax ) Oy + NxAyOx}{AyCxNx} W \\ = ( \frac{1}{Cx} x + \frac{Cx - Ax}{CxAy} y ) W ,\end{matrix}$$

where W indicates a weight of the object 5.

As shown in FIG. 5(c), the three half bridge load cells A, B, C form a triangle plane, where B is at the origin, A is at a position (Ax, Ay), C is at a position (Cx, 0), O(Ox, Oy) indicates the position of an object 5 in the triangle plane, N indicates the center of gravity of the triangle plane, which is at the intersection of midline passing through B and middle of line AC and midline passing through point C and middle of line AB, L5 indicates a line passing through A(Ax, Ay) and the center of gravity N, which intersects a line passing through B to C (line BC) at a point T, and L6 indicates a line passing through origin O(Ox, Oy) and parallel to the line BC, which intersects the line L5 at a point U. The triangle plane formed of the three half bridge load cells A, B, C can be represented as follows:

$$L 5 -> y = \frac{Ay}{Ax - \frac{Cx}{2}} x , \\ L 6 -> y = Oy .$$

T(Tx, Ty) and U(Ux, Uy) can be derived from the above equations (1)-(2) as follows:

$$T ( Tx , Ty ) = ( \frac{Cx}{2} , 0 ) , \\ U ( Ux , Uy ) , \\ Uy = Oy .$$

Thus, the force F_{BC}(Ox, Oy) sensed by the object 5 is:

$${F}_{BC} ( Ox , Oy ) = \frac{Ay - Oy}{Ay} W = ( 1 - \frac{1}{Ay} y ) W ,$$

where W indicates a weight of the object 5. Thus, the position and weight of the object 5 can be derived from the above equations. In addition, the sum of the forces sensed by the object 5 is a double of the weight of the object 5.

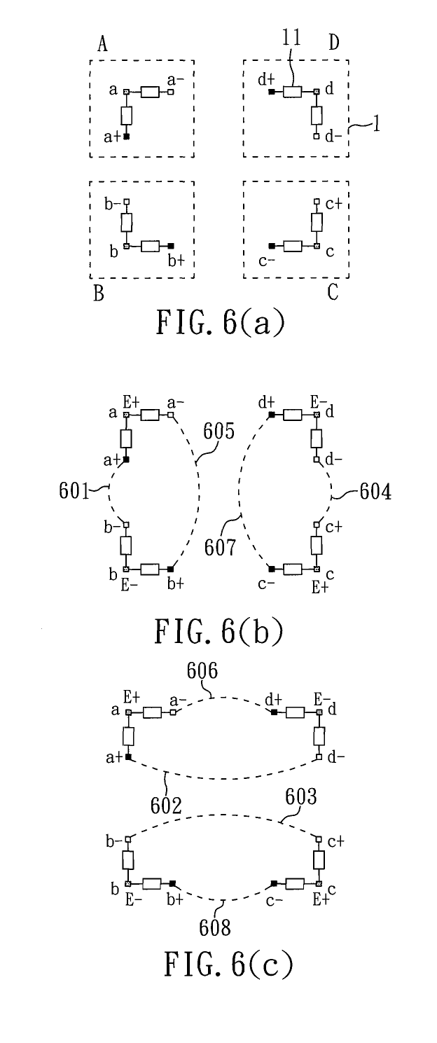

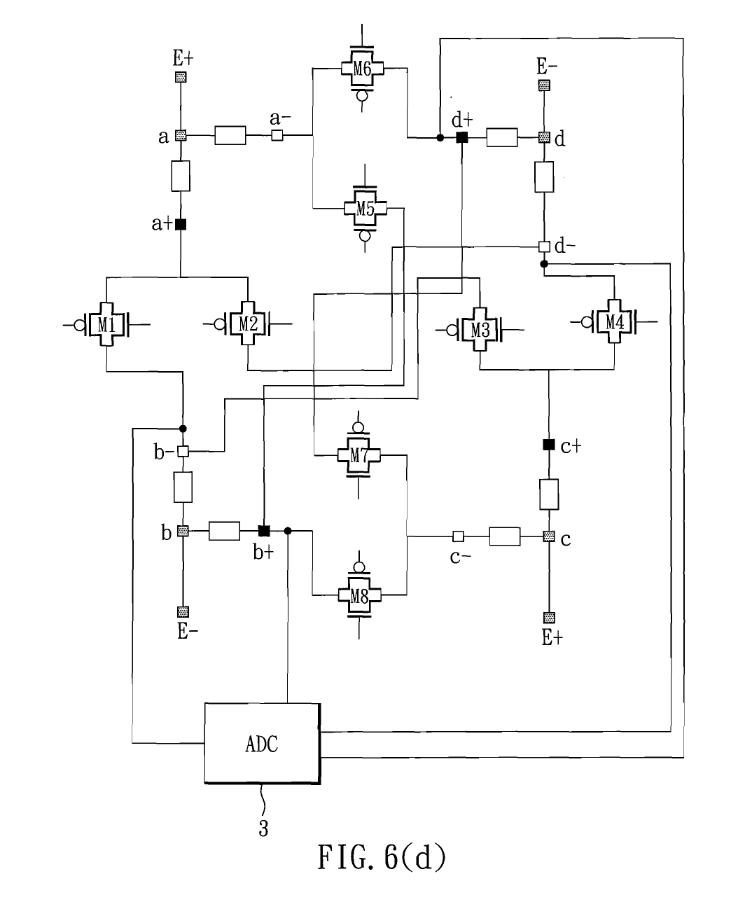

FIGS. 6(a)-(d) show a schematic chart of an operation with four half bridge load cells according to the invention. As shown in FIG. 6(a), symbols A, B, C and D respectively indicate a half bridge load cell 1. The four half bridge load cells A, B, C, D have two load components 11 connected in series and three terminals each. For example, the half bridge load cell A has three terminals a−, a+, a, the half bridge load cell B has three terminals b−, b+, b, the half bridge load cell C has three terminals c−, c+, c, and the half bridge load cell D has three terminals d−, d+, d. FIG. 6(e) further demonstrates the connection of the analog multiplexer 2 and the four half bridge load cells A, B, C, D, in which the analog multiplexer 2 has eight switch units M1-M8. The switch unit M1 has two ends connected to terminal a+ of the half bridge load cell A and terminal b− of the half bridge load cell B, respectively. The switch unit M2 has two ends connected to terminal a+ of the half bridge load cell A and terminal d− of the half bridge load cell D, respectively. The switch unit M3 has two ends connected to terminal b− of the half bridge load cell B and terminal c+ of the half bridge load cell C, respectively. The switch unit M4 has two ends connected to terminal c+ of the half bridge load cell C and terminal d− of the half bridge load cell D, respectively. The switch unit M5 has two ends connected to terminal a− of the half bridge load cell A and terminal b+ of the half bridge load cell B, respectively. The switch unit M6 has two ends connected to terminal a− of the half bridge load cell A and terminal d+ of the half bridge load cell D, respectively. The switch unit M7 has two ends connected to terminal c− of the half bridge load cell C and terminal d+ of the half bridge load cell D, respectively. The switch unit M8 has two ends connected to terminal b+ of the half bridge load cell B and terminal c− of the half bridge load cell C, respectively. The terminal a of the half bridge load cell A and is connected to external voltage source E+. The terminal b of the half bridge load cell B is connected to external voltage source E−. The terminal c of the half bridge load cell C is connected to external voltage source E+. The terminal d of the half bridge load cell D is connected to external voltage source E−. The terminals b−, b+ of the half bridge load cell B and the terminals d−, d+ of the half bridge load cell D are connected to ADC 3.

As shown in FIG. 6(b), the analog multiplexer 2 interconnects the half bridge load cell A and B to form a full bridge load cell and interconnects the half bridge load cell C and D to form another full bridge load cell, wherein the dash line 601 indicates that the switch unit M1 of the analog multiplexer 2 is switched on to connect end point a+ of the half bridge load cell A with end point b− of the half bridge load cell B; the dash line 605 indicates that the switch unit M5 of the analog multiplexer 2 is switched on to connect end point a− of the half bridge load cell A with end point b+ of the half bridge load cell B; the dash line 607 indicates that the switch unit M7 of the analog multiplexer 2 is switched on to connect end point d+ of the half bridge load cell D with end point c− of the half bridge load cell C; the dash line 604 indicates that the switch unit M4 of the analog multiplexer 2 is switched on to connect end point d− of the half bridge load cell D with end point c+ of the half bridge load cell C; external voltage source E+ is connected to end point a of the half bridge load cell A; external voltage source E− is connected to end point b of the half bridge load cell B; external voltage source E+ is connected to end point c of the half bridge load cell C; external voltage source E− is connected to end point d of the half bridge load cell D. Therefore, two full bridge load cells are formed respectively by connecting the terminal a+ of the half bridge load cell A to the terminal b- of the half bridge load cell B and connecting the terminal a− of the half bridge load cell A to the terminal b+ of the half bridge load cell B, and by connecting the terminal c+ of the half bridge load cell C to the terminal d− of the half bridge load cell D and connecting the terminal c− of the half bridge load cell C to the terminal d+ of the half bridge load cell D. Further, the terminal a of the half bridge load cell A, the terminal b of the half bridge load cell B and the terminal c of the half bridge load cell C, the terminal d of the half bridge load cell D are connected to the external voltage source (E+, E−), and in this case the full bridge load cells formed of the half bridge load cells A, B and C, D can detect a first and a second signals.

As shown in FIG. 6(c), the analog multiplexer 2 interconnects the half bridge load cell A and D to form a full bridge load cell and interconnects the half bridge load cell B and C to form another full bridge load cell, wherein the dash line 606 indicates that the switch unit M6 of the analog multiplexer 2 is switched on to connect end point a− of the half bridge load cell A with end point d+ of the half bridge load cell D; the dash line 602 indicates that the switch unit M2 of the analog multiplexer 2 is switched on to connect end point a+ of the half bridge load cell A with end point d− of the half bridge load cell D; the dash line 603 indicates that the switch unit M3 of the analog multiplexer 2 is switched on to connect end point b− of the half bridge load cell B with end point c+ of the half bridge load cell C; the dash line 608 indicates that the switch unit M8 of the analog multiplexer 2 is switched on to connect end point b+ of the half bridge load cell B with end point c− of the half bridge load cell C; external voltage E+ is connected to end point a of the half bridge load cell A; external voltage E− is connected to end point d of the half bridge load cell D; external voltage E+ is connected to end point c of the half bridge load cell C; external voltage E− is connected to end point b of the half bridge load cell B. Therefore, two full bridge load cells are formed respectively by connecting the terminal a+ of the half bridge load cell A to the terminal d− of the half bridge load cell D and connecting the terminal a− of the half bridge load cell A to the terminal d+ of the half bridge load cell D, and by connecting the terminal b+ of the half bridge load cell B to the terminal c− of the half bridge load cell C and connecting the terminal b− of the half bridge load cell B to the terminal c+ of the half bridge load cell C. Further, the terminal a of the half bridge load cell A, the terminal d of the half bridge load cell D and the terminal b of the half bridge load cell B, the terminal c of the half bridge load cell C are connected to the external voltage source (E+, E−), and in this case the full bridge load cells formed of the half bridge load cells A, D and B, C can detect a third and a fourth signal.

The first to fourth signals are transmitted to the ADC for being converted into the digital signals by the ADC 3, and the digital signals are sent to the CPU 4 in order to compute the corresponding position and weight.

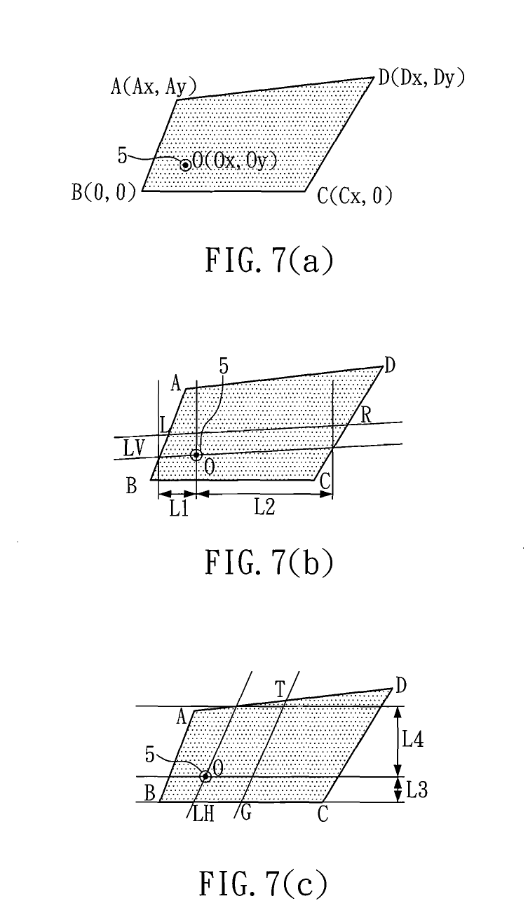

FIGS. 7(a)-(c) show a schematic chart of a computation with four half bridge load cells according to the invention. As shown in FIG. 7(a ), the four half bridge load cells A, B, C, D form a quadrangle plane, where B is at the origin, A is at a position (Ax, Ay), C is at a position (Cx, 0), D is at a position (Dx, Dy), O(Ox, Oy) indicates the position of an object 5 in the quadrangle plane. As shown in FIG. 7(b), L indicates the center of a line passing through A and B (line AB), R indicates the center of a line passing through C to D (line CD), LV indicates a line parallel to a line passing through L and R (line LR) and passing through O(Ox, Oy), L1 indicates a horizontal distance from an intersection of the lines LV and AB to O(Ox, Oy), and L2 indicates a horizontal distance from O(Ox, Oy) to an intersection of the lines LV and CD. In addition, the weight W of the object 5 is distributed over the full bridge load cell formed of the half bridge load cells A and B and the full bridge load cell formed of the half bridge load cells C and D, and accordingly can be represented as follows:

W=F_{AS}(X,Y)+F_{CD}(X,Y),

F_{AB}(X,Y)/F_{CD}(X,Y)=L2/L1,

where F_{AB}(X, Y) indicates a partial weight of the object 5 sensed by the full bridge load cell formed of the half bridge load cells A and B, and F_{CD}(X, Y) indicates a partial weight of the object 5 sensed by the full bridge load cell formed of the half bridge load cells C and D. As shown in FIG. 7(c), G indicates the center of a line segment from B to C (line BC), T indicates the center of a line segment from A to D (line AD), LH indicates a line parallel to a line segment from T to G (line TG) and containing O(Ox, Oy), L3 indicates a vertical distance from an intersection of the lines LH and BC to O(Ox, Oy), and L4 indicates a vertical distance from O(Ox, Oy) to an intersection of the lines LH and AD. In addition, the weight W of the object 5 is distributed over the full bridge load cell formed of the half bridge load cells A and D and the full bridge load cell formed of the half bridge load cells B and C, and accordingly can be represented as follows:

W=F_{AD}(X,Y)+F_{BC}(X,Y),

F_{AD}(X,Y)/F_{BC}(X,Y)=L4/L3,

where F_{AD}(X, Y) indicates a partial weight of the object 5 sensed by the full bridge load cell formed of the half bridge load cells A and D, and F_{BC}(X, Y) indicates a partial weight of the object 5 sensed by the full bridge load cell formed of the half bridge load cells B and C. Therefore, the weight and position of the object 5 can be derived from the four equations above.

Although the present invention has been explained in relation to its preferred embodiment, it is to be understood that many other possible modifications and variations can be made without departing from the spirit and scope of the invention as hereinafter claimed.

What is claimed is:

1. A multi-dimension detector with half bridge load cells for detecting position and weight of an object on three dimensions, comprising:
an analog to digital converter for converting analog signals into digital signals;
three half bridge load cells which are first, second and third half bridge load cells, each having two load components connected in series;
an analog multiplexer for interconnecting the first and second half bridge load cells to form a first full bridge load cell to thereby detect a first force measure corresponding to the object, interconnecting the second and third half bridge load cells to form a second full bridge load cell to thereby detect a second force measure corresponding to the object, interconnecting the first and third half bridge load cells to form a third full bridge load cell to thereby detect a third force measure corresponding to the object, and transmitting the analog signals corresponding to the first, second and third force measures on the first, second and third full bridge load cells to the analog to digital converter for a conversion from the analog signals into the digital signals; and
a central processing unit for determining the position and weight of the object according to the first, second and third force measures corresponding to the digital signals.

2. The multi-dimension detector with half bridge load cells as claimed in claim 1, wherein the central processing unit controls the analog multiplexer to form the first, second and third full bridge load cells by interconnecting the first and second half bridge load cells, by interconnecting the second and third half bridge load cells, and by interconnecting the first and third half bridge load cells, respectively.

3. The multi-dimension detector with half bridge load cells as claimed in claim 1, wherein each of the three half bridge load cells comprises a first and a second terminals at two ends of the two load components and a third terminal at the connection of the two load components.

4. The multi-dimension detector with half bridge load cells as claimed in claim 3, wherein the first and the second terminals of the first half bridge load cell are connected to the first and the second terminals of the second half bridge load cell to thereby form the first full bridge load cell, the first and the second terminals of the second half bridge load cell are connected to the first and the second terminals of the third half bridge load cell to thereby form the second full bridge load cell, and the first and the second terminals of the first half bridge load cell are connected to the first and the second terminals of the third half bridge load cell to thereby form the third full bridge load cell.

5. The multi-dimension detector with half bridge load cells as claimed in claim 1, wherein the object locates in a triangle plane formed of the first, second and third half bridge load cells with relative coordinates of (Ax, Ay), (0, 0) and (Cx, 0).

6. The multi-dimension detector with half bridge load cells as claimed in claim 5, wherein the position (X, Y) and weight W of the object are derived from following equations:
2*W=F_{AB}(X,Y)+F_{BC}(X,Y)+F_{AC}(X,Y), (a)
F_{AB}(X,Y)=W*(1−X/C_{X}+A_{X}Y/C_{X}A_{Y}), (b)
F_{BC}(X,Y)=W*(1−Y/A_{Y}), (c)
F_{AC}(X,Y)=W*[X/C_{X}=Y*(C_{X}−A_{X})/(C_{X}−A_{Y})], (d)
where F_{AB}(X,Y) indicates the first force measure, F_{BC}(X,Y) indicates the second force measure, and F_{AC}(X,Y) indicates the third force measure.

7. A multi-dimension detector with half bridge load cells for detecting position and weight of an object on three dimensions, comprising:
an analog to digital converter for converting analog signals into digital signals;
four half bridge load cells which are first, second, third and fourth half bridge load cells, each having two load components connected in series;
an analog multiplexer for interconnecting the first and second half bridge load cells to form a first full bridge load cell to thereby detect a first force measure corresponding to the object, interconnecting the third and fourth half bridge load cells to form a second full bridge load cell to thereby detect a second force measure corresponding to an object, interconnecting the first and fourth half bridge load cells to form a third full bridge load cell to thereby detect a third force measure corresponding to the object, interconnecting the second and third half bridge load cells to form a fourth full bridge load cell to thereby detect a fourth force measure corresponding to the object, and transmitting the analog signals corresponding to the first, second, third and fourth force measures on the first, second, third and fourth full bridge load cells to the analog to digital converter for a conversion from the analog signals into the digital signals; and
a central processing unit for determining the position and weight of the object according to the first, second, third and fourth force measures corresponding to the digital signals.

8. The multi-dimension detector with half bridge load cells as claimed in claim 7, wherein the central processing unit controls the analog multiplexer to form the first, second, third and fourth full bridge load cells by interconnecting the first and second half bridge load cells, by interconnecting the third and fourth half bridge load cells, by interconnecting the first and fourth half bridge load cells and by interconnecting the second and third half bridge load cells, respectively.

9. The multi-dimension detector with half bridge load cells as claimed in claim 7, wherein each of the half bridge load cells comprises three terminals.

10. The multi-dimension detector with half bridge load cells as claimed in claim 9, wherein each of the four half bridge load cells comprises a first and a second terminals at two ends of the two load components and a third terminal at the connection of the two load components.

11. The multi-dimension detector with half bridge load cells as claimed in claim 10, wherein the first and the second terminals of the first half bridge load cell are connected to the first and the second terminals of the second half bridge load cell to thereby form the first full bridge load cell, the first and the second terminals of the third half bridge load cell are connected to the first and the second terminals of the fourth half bridge load cell to thereby form the second full bridge load cell, the first and the second terminals of the first half bridge load cell are connected to the first and the second terminals of the fourth half bridge load cell to thereby form the third full bridge load cell, and the first and the second terminals of the second half bridge load cell are connected to the first and the second terminals of the third half bridge load cell to thereby form the fourth full bridge load cell.

12. The multi-dimension detector with half bridge load cells as claimed in claim 7, wherein the object locates in a quadrangle plane formed of the first, second, third and fourth half bridge load cells with relative coordinates of (Ax, Ay), (0, 0), (Cx, 0) and (Dx, Dy).

13. The multi-dimension detector with half bridge load cells as claimed in claim 12, wherein the position (X, Y) and weight W of the object are derived from following equations:
W=F_{AB}(X,Y)+F_{CD}(X,Y), (a)
W=F_{AD}(X,Y)+F_{BC}(X,Y), (b)
F_{AB}(X,Y)/F_{CD}(X,Y)=L2/L1, (c)
F_{AD}(X,Y)/F_{BC}(X,Y)=L4/L3, (d)
where F_{AB}(X,Y) indicates the first force measure, F_{CD}(X,Y) indicates the second force measure, F_{AD}(X,Y) indicates the third force measure, and F_{BC}(X,Y) indicates the fourth force measure.
